(19) United States
(12) Patent Application Publication
(10) Pub. No.: US 2015/0058116 A1
(43) Pub. Date: Feb. 26, 2015

(54) IN-MARKET CLASSIFICATION FOR ONLINE CONTENT ITEM PLACEMENT CAMPAIGNS

(71) Applicant: Google Inc., Mountain View, CA (US)

(72) Inventors: Ting Liu, Sunnyvale, CA (US); Yingyi Qi, Shanghai (CN)

(73) Assignee: Google Inc., Mountain View, CA (US)

(21) Appl. No.: 14/091,279

(22) Filed: Nov. 26, 2013

Related U.S. Application Data
(63) Continuation of application No. PCT/CN2013/082295, filed on Aug. 26, 2013.

(51) Int. Cl. G06Q 30/02

(52) U.S. Cl. CPC G06Q 30/0246
USPC 705/14.45

(57) ABSTRACT

At least one aspect is directed to identifying in-market activity for content placement as part of an online content item placement campaign. A data processing system can determine renderings of online documents by an end user computing device within a time period, and can classify the online documents into a top level subject matter category. At least one of a plurality of sub-categories of the top level subject matter category can be identified as an in-market category that includes some of the online documents. A number of renderings of the plurality of online documents during the time period, and a number of conversions associated with the renderings can be determined A score can be assigned to the end user computing device based on the number of renderings and the number of conversions. Based on the score, the end user computing device can be classified as in-market or out of market.

### CROSS-REFERENCE TO RELATED PATENT APPLICATIONS

This application is a continuation of International Application number PCT/CN2013/082295, filed Aug. 26, 2013, which is incorporated by reference herein in its entirety.

### BACKGROUND

In a computer networked environment such as the internet, entities such as people or companies provide information for public display on documents such as web pages. The documents can include information provided by the entities via a computing device for display on the internet. Content can also be provided by third parties for display on the documents together with the information provided by the entities. Thus, a person viewing a document can access the information that is the subject of the document, as well as third party content that may or may not be related to the subject matter of the document.

### SUMMARY

At least one aspect is directed to a computer implemented method. The computer implemented method may include a method of identifying in-market activity for placement of content as part of an online content item placement campaign via a computer network. The method can determine, by a data processing system, rendering of online documents via the computer network by an end user computing device within a time period. The method can classify, by the data processing system, the online documents into a top level subject matter category, and can identify, by the data processing system based on communication with a database, one of a plurality of sub-categories of the top level subject matter category as an in-market category. The method can include a plurality of the online documents in the in-market category, and can determine a number of renderings of the plurality of online documents during the time period. The method can determine a number of conversions associated with the renderings of the plurality of online documents during the time period, and can assign a score to the end user computing device based on the number of renderings of the plurality of online documents and the number of conversions of the plurality of online documents. The method can classify based on the score, the end user computing device as one of an in-market device and an out of market device for placement of a content item as part of the online content item placement campaign. The in-market device can have a higher likelihood to convert the content item than the out of market device.

At least one aspect is directed to a system of identifying in-market activity for placement of content as part of an online content item placement campaign via a computer network. The system can include one or more data processors, and one or more storage devices storing instructions that when executed by the one or more data processors, cause the one or more data processors to perform operations. The operations can include identifying rendering of online documents via the computer network by an end user computing device within a time period, and classifying the online documents into a top level subject matter category. The operations can include identifying one of a plurality of sub-categories of the top level subject matter category as an in-market category, and including a plurality of the online documents in the in-market category. The operations can include determining a number of renderings of the plurality of online documents during the time period, and determining a number of conversions associated with the renderings of the plurality of online documents during the time period. The operations can include assigning a score to the end user computing device based on the number of renderings of the plurality of online documents and the number of conversions of the plurality of online documents, and classifying, based on the score, the end user computing device as one of an in-market device and an out of market device for placement of a content item as part of the online content item placement campaign.

At least one aspect is directed to a computer readable storage medium device storing instructions that when executed by one or more data processors, cause the one or more data processors to perform operations. The operations include detecting rendering of online documents via the computer network by an end user computing device within a time period, and classifying the online documents into a top level subject matter category. The operations include identifying one of a plurality of sub-categories of the top level subject matter category as an in-market category, and including a plurality of the online documents in the in-market category. The operations include determining a number of renderings of the plurality of online documents during the time period, and determining a number of conversions associated with the renderings of the plurality of online documents during the time period. The operations include assigning a score to the end user computing device based on the number of renderings of the plurality of online documents and the number of conversions of the plurality of online documents, and classifying, based on the score, the end user computing device as one of an in-market device and an out of market device for placement of a content item as part of the online content item placement campaign.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting one example environment to identify in-market activity according to an illustrative implementation;

FIG. 2 is a block diagram depicting one example environment to identify in-market activity according to an illustrative implementation;

FIG. 3 is a flow diagram depicting one example environment to identify in-market activity according to an illustrative implementation;

FIG. 4 is a flow diagram depicting one example environment to identify in-market activity for placement of content as part of an online content item placement campaign via a computer network, according to an illustrative implementation; and

FIG. 5 is a is a block diagram illustrating a general architecture for a computer system that may be employed to implement elements of the systems and methods described and illustrated herein, according to an illustrative implementation.

### DETAILED DESCRIPTION

Following below are more detailed descriptions of various concepts related to, and implementations of, methods, apparatuses, and systems of providing information via a computer network. The various concepts introduced above and discussed in greater detail below may be implemented in any of numerous ways, as the described concepts are not limited to any particular manner of implementation.

Systems and methods of the present disclosure relate generally to determining whether or not end user computing devices or online documents such as web pages are in-market or out of market, where an in-market end user computing device is more likely to convert a content item than an out of market end user computing device, and where an in-market online document is more likely to be associated with conversions (e.g., clicks on links or content items of the online document) than an out of market online document. In-market computing devices or in-market online documents such as web pages can be selected for the placement of ads or other content items as part of an online content item placement campaign.

To make the in-market or out of market classification, the data processing system can select a top level subject matter category, such as the vehicle related category “Autos and Vehicles or Motor Vehicles”. A large number of web pages or other online documents may fall into this category. Within this top level subject matter category, the data processing system can select a sub category that may be more susceptible to in-market activity, such as the sub category “Autos and Vehicles.” The data processing system can evaluate renderings or conversions of the online documents in the “Autos and Vehicles” sub category (e.g., online documents relevant to autos or vehicles) to determine which of those online documents have a greater likelihood of attracting in-market end user computing devices, e.g., computing devices associated with end users that are in the market for a particular good or service, or end users having a higher likelihood of converting a content item than a general population of end users.

For example, the data processing system can determine a score based on a number of renderings and a number of conversions of online documents in the sub-category by an end user computing device. Based on the score, (e.g., by comparing the score with a threshold value), the data processing system can classify the end user computing device as in-market, e.g., more likely to click an ad or otherwise convert a content item than a general population of end user computing devices.

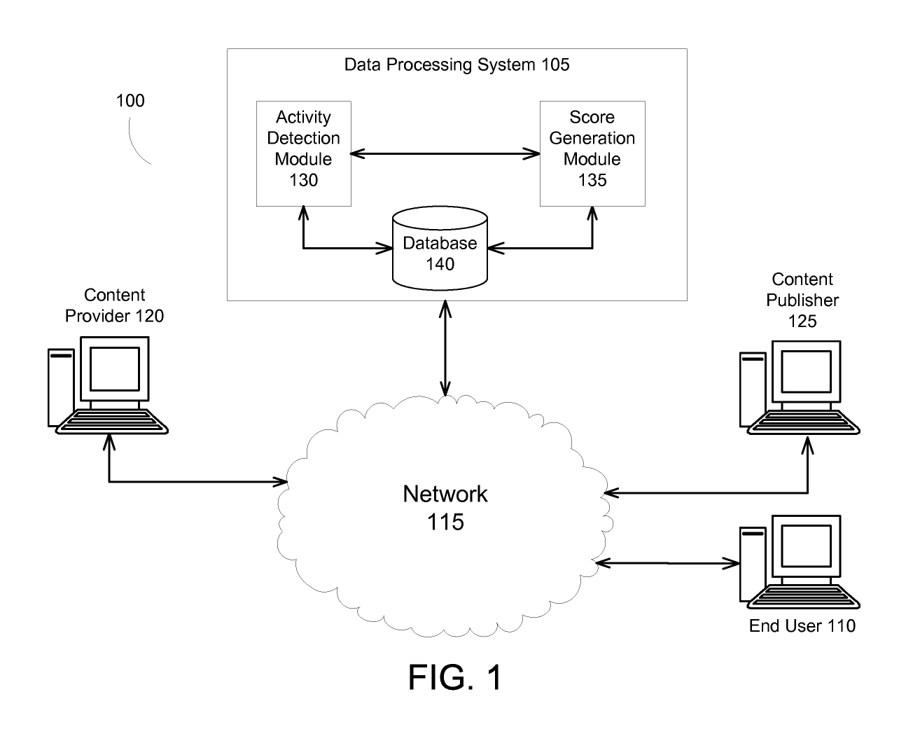

FIG. 1 illustrates a system 100 for identifying in market activity. The system 100 can include at least one data processing system 105 to identify in market activity of at least one end user computing device 110. An in-market determination made by the data processing system 105 can indicate that the end user computing device 110 has an increased likelihood relative to a threshold, average, or general population of end user computing devices to click a link or ad of a web page, or otherwise convert a content item of an online document. For example, the data processing system 105 can determine that the end user computing device 110 is an in-market end user computing device without determining any personally identifiable information about any end user operating the end user computing device 110.

The system 100 can include at least one network 115. The network 115 can include computer networks such as the internet, local, wide, metro or other area networks, intranets, satellite networks, other computer networks such as voice or data mobile phone communication networks, and combinations thereof The data processing system 105, e.g., at least one logic device such as a computing device or server having a processor, can communicate via the network 115, for example with the end user computing device 110, at least one content provider computing device 120, or at least one content publisher computing device 125.

The data processing system 105 can include at least one server. For example, the data processing system 105 can include a plurality of servers located in at least one data center or server farm. In one implementation, the data processing system 105 includes, or communicates via the network 115 with, a content placement system, e.g., an ad server or ad placement system, to provide content items (e.g., ads) of the content provider computing device 120 for display with online documents (e.g., weg pages) of the content publisher device 125 by the end user computing device 110. The data processing system 105 or its components can include or be part of at least one virtual server.

The content provider computing devices 120 can include servers or other computing devices operated by a content provider entity to provide content items such as advertisements for display on information resources at the end user computing device 110. The content provided by the content provider computing device 120 can include third party content items (e.g., ads) for display on information resources such as a web page that includes primary content, e.g. content provided by the content publisher computing device 125. For example, the content provider computing device 120 can provide or be the source of ads or other content items for display in content slots of content web pages such as a web page of a company where the primary content of the web page is provided by the company, or for display on a search results landing page provided by a search engine. The content items associated with the content provider computing device 120 can be displayed on information resources other than web pages, such as content displayed as part of the execution of an application on a smartphone or other end user computing device 110.

The content publisher computing devices 125 can include servers or other computing devices operated by a content publishing entity to provide primary content for display via the network 115. For example, the content publisher computing device 125 can include a web page operator who provides primary content for display on the web page. The primary content can include content other than that provided by the content publisher computing device 125, and the web page can include content slots configured for the display of third party content items (e.g., ads) from the content provider computing device 120. For example, the content publisher computing device 125 can operate the website of a company and can provide content about that company for display on web pages of the website. The web pages can include content slots configured for the display of third party content items such as ads of the content provider computing device 120. In some implementations, the content publisher computing device 125 includes a search engine computing device (e.g. server) of a search engine operator that operates a search engine website. The primary content of search engine web pages (e.g., a results or landing web page) can include results of a search as well as third party content items displayed in content slots such as content items from the content provider computing device 120.

The end user computing devices 110 can include computing devices configured to communicate via the network 115 to display data such as the content provided by the content publisher computing device 125 (e.g., primary web page content or other information resources) and the content provided by the content provider computing device 120 (e.g., third party content items such as ads configured for display in a content slot of a web page). The end user computing device 110 can include desktop computers, laptop computers, tablet computers, smartphones, personal digital assistants, mobile devices, end user computing devices, consumer computing device, and other computing devices. The end user computing device 110 can include user interfaces such as microphones, speakers, touchscreens, keyboards, pointing devices, a computer mouse, touchpad, or other input or output interfaces.

The data processing system 105 can include at least one activity detection module 130, at least one score generation module 135, and at least one database 140 as part of one or more physical or virtual servers of an in-market identification system to determine that the end user computing device 110 is an in-market device or to determine that an online document of the content publisher computing device 125 is an in-market online document. For example, the activity detection module 130 can be part of, or can include scripts executed by, one or more servers of the data processing system 105 configured to classify (e.g., determine or otherwise identify) end user computing devices 110 as in-market devices based on renderings or conversions of online documents by the end user computing devices 110.

The score generation module 135 can be part of the same or a different server as the activity detection module 130 in the data processing system 105. The score generation module 135 can evaluate output of the activity detection module 130 to determine a score assigned to end user computing devices 110, or to online documents of the content publisher 125. For example, based on renderings or conversions of an online document, the score generation module 135 can generate a score indicating that the end user computing device 110 is in-market or out of market.

The activity detection module 130 and the score generation module 135 can each include at least one processing unit, physical server, virtual server, circuit, engine, or other logic device such as programmable logic arrays configured to communicate with the database 140 and with other computing devices (e.g., the end user computing device 110, the content provider computing device 120, or the content publisher computing device 125) via the network 115. The activity detection module 130 and the score generation module 135 can include at least one computer program or at least one script. The activity detection module 130 and the score generation module 135 can be separate components, a single component, or part of the data processing system 105. The activity detection module 130 and the score generation module 135 can include combinations of software and hardware, such as one or more processors configured to execute one or more scripts to classify the end user computing device 110 as an in market device.

The data processing system 105 can also include at least one database 140. The database can communicate with or be part of the data processing system 105 and its components such as the activity detection module 130 or the score generation module 135. The database 140 generally includes a data structure to store data that can be input to and retrieved from the database 140 by the data processing system.

In some implementations, to identify in-market activity that can be used to direct the placement of ads or other content items via the network 115 as part of a content item placement campaign, the data processing system 105 can determine the rendering of online documents by at least one end user computing device 110. For example, via the network 115, the end user computing device 110 can communicate with the content publisher computing device 125 to access a web page or other online document for rendering (e.g., display) by the end user computing device 110. The data processing system 105 (or a component thereof such as the activity detection module 130) can obtain, via the network 115 from the end user computing device 110 or from the content publisher computing device 125, an indication of this rendering of the online document. In some implementations, the data processing system 105 determines (e.g., detects) renderings of online documents based on information retrieved from the database 140, or from another database external to the data processing system 105.

The data processing system 105 can determine or otherwise detect the rendering of online documents by the end user computing device 110 during a time period, such as a period of days, weeks, one week, two weeks, or other longer or shorter discrete time periods. In one implementation, the time period is an open ended or ongoing time period without a defined end time. During this time period, the data processing system can determine a plurality of renderings of the same or different online documents one or more than one end user computing device 110. The data processing system 105 can determine a large number (e.g., thousands or hundreds of thousands) of renderings of online documents by a large number of end user computing devices 110.

In some implementations, the data processing system 105 can classify the online documents into a top level subject matter category. For example, the data processing system 105 can group the online documents into top level categories based broadly on the content or subject matter of the online documents. An example top level subject matter category is “Autos & Vehicles/Motor Vehicles” for online documents having subject matter related to automobiles, vehicles or motor vehicles including, for example, cars, trucks, buses, tractors, motorcycles, scooters, or industrial vehicles. The online documents including this subject matter can vary widely within this category. For example, the data processing system 105 can classify a first web page offering cars for sale and a second web page for a television show about cars (that does not offer cars for sale) into the same top level category “Autos & Vehicles/Motor Vehicles.” In this example, the data processing system 110 determines that the first and second web pages are both in the same top level subject matter category even though the first web page (e.g., offering cars for sale) may be directed toward in-market end users who are in the market to purchase a car, and the second web page (e.g., for a television show about cars) may be directed toward end users that are car simply enthusiasts and less likely to be actively in the market to purchase a car.

The data processing system 105 can identify sub-categories of the top level subject matter category. For example, the data processing system 105 can obtain from the database 140 a list of sub-categories of the top level subject matter category “Autos & Vehicles/Motor Vehicles,” such as the sub category “Autos & Vehicles.” The sub-category need not share a part of its name with the top level subject matter category. For example, sub-categories of the top level “Autos & Vehicles/Motor Vehicles” category can be “cars” motorcycles” or “automobiles”. The sub-category can be an in-market category, e.g., a sub-category of the top level subject matter category that is the subject of evaluations by the data processing system 105 to determine whether or not the end user computer devices 110 that access the online documents of the sub-category are in-market or out of market. Various taxonomies or classification schemes can be used to determine the top level, or broader, subject matter category and the more narrowly focused sub-category.

In some implementations, the activity detection module 130 can determine that an online document is rendered at the end user computing device 110, and can determine both the top-level subject matter category and the sub-category to which the online document belongs, (e.g., the data processing system 105 can classify the online document). For example, the activity detection module 130 can determine that a web page indicating the value of used cars is classified in the top level subject matter category “Autos & Vehicles/Motor Vehicles” and also in the sub-category “Autos & Vehicles.” In this example, the data processing system 105 can select online documents in this sub-category for evaluation to determine if the end user computing devices 110 that render these online documents is an in-market device or an out of market device. The sub-category subject to this evaluation can be referred to as the in-market category. This does not necessarily mean that online documents in this sub-category are in-market, or that end user computing devices 110 rendering the online documents in this sub-category are in-market computing devices. Rather, a sub-category evaluated by the data processing system 105 for in-market activity can be referred to as an in-market sub-category irrespective of the degree to which the associated end user computing devices 110 or online documents indicate in-market activity via the network 115.

The data processing system 105 can include a plurality of online documents in the in-market sub-category. The online documents in the sub-category can be evaluated by the data processing system 105 to classify one or more of the end user computing devices 110 as in-market devices, with online documents that are included in the top-level subject matter category but not in the selected sub-category not considered in determining whether or not the end user computing device 110 is an in-market device. In some implementations, the data processing system 105 excludes online documents in the in-market sub-category. For example, from information in the database 140 or an analysis of subject matter of online documents, the data processing system 110 can determine that online documents have subject matter that is different than subject matter of the in-market sub-category. In this example, the data processing system 105 can exclude those online documents from the in-market category.

Not all sub-categories of the top level subject matter category are in-market categories. For example, the data processing system 105 can communicate with the database 140 to obtain a listing of the sub-categories of the top level subject matter category (e.g., “Autos & Vehicles/Motor Vehicles”) and can determine that the sub-category “Autos & Vehicles” is an in-market category, and that other sub categories (e.g. “Motor Vehicles” “Trucks” or “Motorcycles” are out of market categories.

In one implementation, the data processing system 105 determines a number of renderings of the online documents in the in-market sub-category. For example, the activity detection module 130 can determine that an end user computing device 110 renders ten web pages about cars that are included in the “Autos & Vehicles” sub-category of the “Autos & Vehicles/Motor Vehicles” top level subject matter category. The activity detection module 130 can obtain rendering information via the network 115 from the end user computing device 110, from the content publisher computing device 125, or from the database 140, for example. The activity detection module 130 (or other data processing system 105 component) can determine the number of renderings of online documents of the sub-category within a time period, such as a one week time period or a two week time period, for example. In some implementations, the data processing system 105 detects renderings (e.g., impressions or views) of online documents of the in-market sub-category by one end user computing device 110 based for example on end user computing device 110 cookie data that an end user associated with the end user computing device 110 has elected to make available to the data processing system 105.

The data processing system 105 can also detect a number of conversions of the online documents in the in-market sub-category. A conversion can include a click on a link or content item of an ad that is displayed with a web page or other online document, or further activity such as a purchase of a good or service associated with the click. In some implementations, the data processing system 105 can determine how many web pages in the sub-category are converted. For example, the activity detection module 130 can identify conversions within a time period of some days or weeks.

In some implementations, the data processing system 105 detects conversions associated with the renderings of the online documents of the in-market sub-category. For example, the activity detection module 130 can determine, from activity via the network 115, how many conversions occurred for at least some of the online documents that were rendered by one or more end user computing device 110. In one implementation, a number of conversions of the online documents is the number of clicks on content items (e.g., ads, buttons, or links) of or appearing with the rendered online documents. The number of conversions can also indicate additional activity subsequent to clicks on content items. For example, a click on a content item rendered with a first online document can cause a browser of the end user computing device 110 to navigate to a second online document such as an ad that can be accessed by the end user computing device 110 to purchase a good or service. In this example, the activity detection module 130 can identify the purchase as the conversion associated with the rendering of the first online document. In some implementations the activity detection module 130 determines that there are zero conversions associated with renderings of the online documents in the in-market sub-category.

The data processing system 105 or a component thereof such as the score generation module 135 can assign a score to the end user computing device 110. For example, the score generation module 135 can determine a score for one of the end user computing devices 110 based on the number of renderings (e.g., impressions or page views) of online documents by the end user computing device 110 within a time period, and also based on the number of conversions by the end user computing device 110 associated with those renderings. The data processing system 105 can assign the score to the end user computing device 110.

The data processing system 105 can obtain end user consent via the end user device 110 to evaluate cookies from a web browser of the end user computing device 110 to determine, with end user consent, renderings and conversions of online documents by the end user computing device 110. Any end user of the end user computing device is not personally identified. For example, an end user (a person) may use two different computing devices 110 at the same or different times. The data processing system 105, with end user consent, can evaluate cookies of the two end user computing devices 110 to determine renderings or conversions without personally identifying the end user and without determining that the same end user is operating the two end user computing devices 110.

In some implementations, the data processing system 105 extracts information from the rendered online documents to determine the subject matter of the online documents. For example, the activity detection module 130 can determine the subject matter of a plurality of online documents rendered by a plurality of end user computing devices 110. The data processing system 105 can group or classify the online documents into the sub-categories, and for at least one of the sub-categories, the data processing system 105 can use a learning regression or machine learning analysis to determine the end-user computing devices 110 that are in-market devices based on rendering and conversion data.

For example, the data processing system 105 can determine that individual renderings (e.g., web page views) are in-market renderings or out of market renderings based, for example, on whether or not the rendering is associated with a conversion (e.g., a click on a content item or a click plus further activity such as a purchase) or based on subject matter of the web page that is or was viewed. The data processing system 105 can determine that some renderings associated with an end user computing device 110 are in-market renderings, and that other renderings associated with the same end user computing device are out of market renderings. From this information, the data processing system 105 can identify that end user computing device 110 as an in-market or out of market end user computing device.

In some implementations, based on the score, the data processing system 105 can classify the end user computing device 110 as an in market device or an out of market device. For example, the data processing system can determine ten renderings of online documents of the in-market sub-category by the end user computing device 110 within a time period of two weeks. Of these ten renderings, the data processing system 105 can identify three conversions. From this rendering and conversion information, the score generation module 135 can determine a score for the end-user computing device 110. The data processing system 105 can compare the score with a threshold value, where for example scores above the threshold value indicate that the end user computing device 110 is an in-market device, and scores below the threshold value indicate that the end user computing device 110 is an out of market device. In this example, an in-market device has a greater likelihood to convert an ad or other content item having subject matter related to subject matter of the in-market sub category than an out of market device. The data processing system 105 can identify or classify the end user computing device 110 as an in-market or out of market device. Any end users associated with the end user computing device 110 remain anonymous and are not personally identified.

The classification of the end user computing devices 110 as in-market or out of market devices can be used to place ads or other content items of the content provider computing device 120 for display by the end user computing device 110 via the network 115 as part of a content item placement campaign. For example, the data processing system 105 can include or communicate with a content item placement server. The content item placement server can receive a request for a content item to provide for display with an online document of the content publisher 125 by the end user computing device 110. The content item placement server can determine whether or not the end user computing device 110 is classified as an in-market device or an out of market device, and can use this information to select a content item for display by the end user computing device 110.

The score generation module 135 can generate or adjust the score of an end user computing device 110 based on the temporal sequence of online document renderings and conversions by the end user computing device. For example, the activity detection module 130 can determine that the end user computing device 110 had ten renderings and one conversion of online documents of the in-market sub-category within a time period of one week. In this example, the activity detection module 130 can determine that the conversion is associated with the sixth rendering. Thus, in this example, six renderings (renderings one through six) occurred before or with the conversion, and three renderings (renderings seven through ten) occurred subsequent to the conversion.

Continuing with the above example, the data processing system 105 can determine that the end user computing device 110 is in-market (e.g., searching for a good or service) and more likely to convert a content item of an online document for the first six renderings, and out of market (e.g., browsing online documents and no longer searching for a good or service) for renderings seven through ten, as the end user computing device 110 has already converted at page view or rendering number six in this example. The score generation module 135 can use this information to generate or adjust the score. For example, the score generation module 135 can adjust the score (e.g., upward) to indicate an increased likelihood that the end user computing device 110 is an in-market device based on renderings one through six—the number of renderings prior to the conversion—and can adjust the score (e.g., downward) to indicate a decreased likelihood that the end user computing device 110 is an in-market device based on renderings seven through ten—the number of renderings subsequent to the conversion. The data processing system 105 can compare the resulting score to a threshold value to indicate that the end user computing device 110 is an in-market device or an out of market device.

In one implementation, the data processing system 105 assigns a positive integer value for in market renderings (e.g., renderings one through six in the above example) and a negative integer value for out of market renderings (e.g., renderings seven through ten in the above example) and uses a threshold value of zero to determine whether or not the end user computing device 110 is an in-market device. With this example scoring and threshold value of zero, the score generation module 135 would generate a score of +2 for the end user computing device 110 in the above example. This score indicates the difference between a +6 value for renderings one through six, and a −4 value for renderings seven through ten. In this example, the score of +2 is greater than the threshold value of zero, indicating that the end user computing device 110 is an in-market device.

The data processing system 105 can declassify or change the classification of end user computing devices 110. For example, the end user computing device 110 can be classified as an in-market device for a period of time, such as a period of days, weeks, or months. Upon expiration of this in-market time period the end user computing device 110 can be declassified as an in-market device. The data processing system 105 can determine that the end user computing device, once declassified, is of indeterminate classification (e.g., neither in-market nor out of market).

In some implementations, the data processing system 105 classifies online documents of the sub-category as in-market or out of market online documents. For example, the activity detection module 130 can determine renderings and conversions of online documents of the in-market sub-category, or of the broader top-level subject matter category that includes the in-market category. In this example, the score generation module 135 can generate scores for the online documents based on renderings or conversions of those documents, and assign the score to the online document.

This score can be compared to a threshold value to classify the online document as an in-market online document or an out of market online document, where an in-market online document has a higher likelihood of conversions than an out of market online document. For example a web page having subject matter about the value of new or used cars or car purchases can be identified by the data processing system 105 as an in-market online document, as visitors to this web page may be more likely to convert content items on this web page, and a hobby-oriented web page having pictures of cars may attract more visitors who are browsing the pictures without intention to purchase items via conversions of content items displayed with the hobby-oriented web page.

The score generated by the data processing system 105 can indicate that the end user computing device 110 is an in-market device that is in the market for a good or service and more likely relative to other end user computing devices 110 to click or convert a content item. The score can also indicate that the end user computing device is not in the market, e.g., an out of market device that is less likely relative to other end user computing devices 110 to click of convert a content item. An out of market device may be referred to as an enthusiast end user device more likely to browse online documents than to convert them. The content provider computing device 120 may be more interested in selecting content items for display by an in-market end user computing device 110, rather than by an out of market (enthusiast) end user computing device 110. In some implementations, the data processing system 105 generates the score that can be used by a content item placement system, (that can be part of the data processing system 105 or a separate system) to select content items for display by the in-market end user computing device 110.

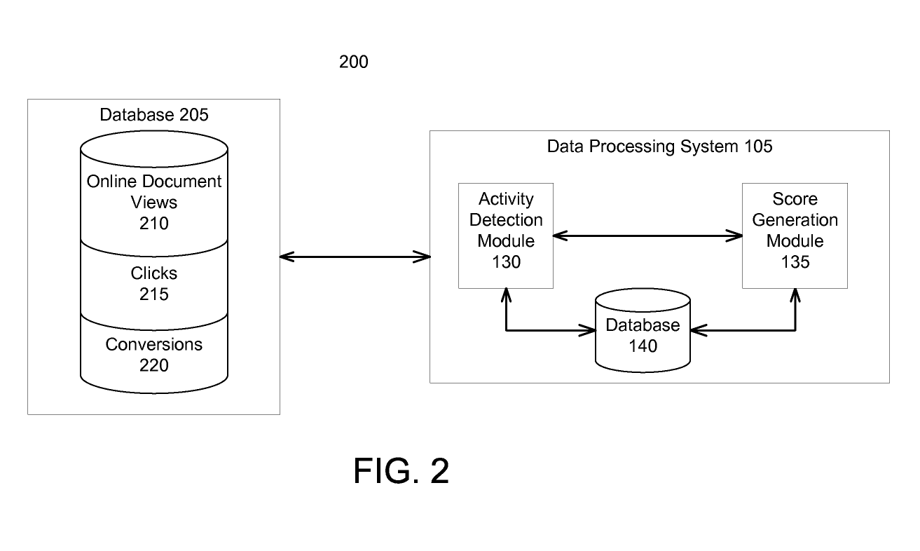

FIG. 2 depicts an example system 200 to identify in-market activity according to an illustrative implementation. The system 200 can include the data processing system 105 and its components. The system 200 can also include at least one database 205. The database 205 can be an offline repository having online document view data 210 (e.g., renderings), click data 215 and conversion data 220. The data processing system 105 can identify the clicks 215 as the conversions 220, or can determine that the conversion 220 includes more than just the click 215 on an online document. For example, the conversion 220 can include data indicating activity taken subsequent to the click 215, such as a purchase of a good or service.

In one implementation, the data processing system 105 obtains the online document view data 210, the click data 215, and the conversion data 220 from the database 205 and stores it for example in the database 140. The data processing system 110 can obtain this data during a defined time period, such as one week, two weeks, or a number of days, weeks, or months. The online document view data 210 can include information about the subject matter of the online documents. The data processing system 105 can filter the online document view data 210 to exclude online documents that are not included in an in-market sub-category under evaluation for in-market activity. In this example, the data processing system 105 retains at least temporarily the online document view data 210 that are relevant to an in-market sub-category (e.g., “Autos & Vehicles”) and discards or filters out other online document view data 210 related to online documents that are not part of this sub-category. In one implementation, the database 205 and the database 140 are part of the same database, data structure, or repository.

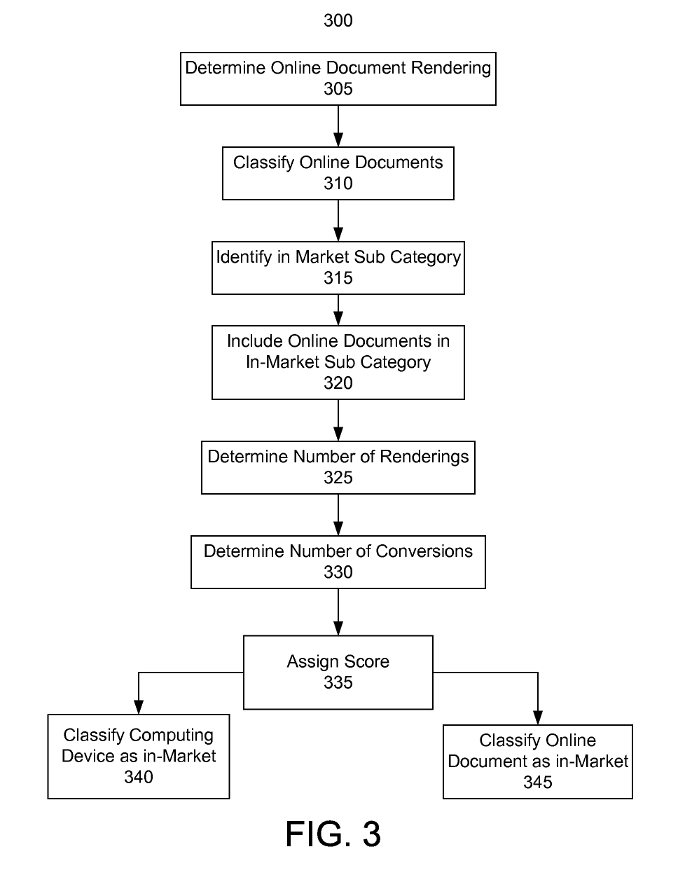

FIG. 3 is a flow diagram depicting a method 300 to identify in-market activity according to one implementation. The method 300 can determine online document renderings (ACT 305). For example, the data processing system 105 can determine web page or other online document renderings by the end user computing devices 110. The online document renderings can be determined (ACT 305) during a time period of a number of days or weeks, or other time period.

The method 300 can classify the online documents into a top level subject matter category (ACT 310). For example, the data processing system 105 can categorize online documents into top level subject matter categories (ACT 310) based on subject matter of the online documents and a listing of top level subject matter categories retrieves from the database 140 or the database 205. In some implementations, the method 300 identifies sub-categories of the top level subject matter category (ACT 315). For example, the data processing system 105 can communicate with the database 140 to identify a sub-category as an in-market category (ACT 315). The in-market sub-category can include a sub-category under evaluation by the data processing system 105 to identify in-market end user computing devices 110.

In some implementations, the method 300 includes at least some of the online documents of the top level subject matter category in the in-market sub-category (ACT 320). For example, the data processing system 105 can associate online documents with the in-market sub-category based on the subject matter of the online documents and the criteria or subject matter of the in-market sub-category. The method 300 can also determine a number of renderings of the online documents of the in-market sub-category (ACT 325). For example, the data processing system 105, with user consent, can communicate with the database 140 to evaluate cookies to determine web page views or other online document renderings of online documents in the in-market sub-category by the end user computing device 110 (ACT 325). In one implementations, the data processing system 105 determines the number of renderings (ACT 325) during the same time period

The method 300 can detect a number of conversions associated with the renderings of the online documents (ACT 330). For example, the data processing system 105 can evaluate cookie information to determine which of the number of renderings of the online documents in the sub-category are associated with a conversion (ACT 330). In one implementation, the data processing system 105 identifies clicks on the rendered online documents as conversions.

In some implementations, the method 300 assigns a score to the end user computing device (ACT 335). For example, based on the determined number of renderings (ACT 325) and the determined number of conversions (ACT 330), the data processing system 105 can assign a score to the end user computing device 110 (ACT 335). The assigned score can indicate whether or not the end user computing device 110 is an in-market device or an out of market device. The method 300 can classify the end user computing device 110 as an in-market device (ACT 340). For example, the data processing system 105 can determine, based on the score, that the end user computing device 110 is in the market to purchase goods or services, or has a higher likelihood than other end user computing devices 110 to click on content items of online documents of the sub-category. The classification of the end user computing device 110 as an in-market device (ACT 340) can be used by a content item placement system to place content items for rending by the end user computing device 110 via the network 115 as part of an online content item placement campaign.

The method 300 can also classify at least one online document of the sub-category as an in-market online document (ACT 345). For example, based on the subject matter of the online document or the score of an end users device 110 that has accessed the online document, the data processing system 105 can determine that the online document has a higher likelihood of being converted (or that content items rendered with the online document have a higher likelihood of being converted) than other online documents of the sub-category, or than general population of online documents.

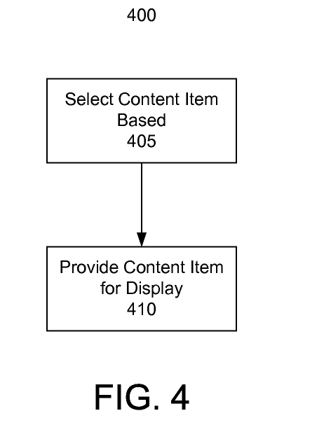

FIG. 4 is a flow diagram depicting a method 400 to identify in-market activity for placement of content as part of an online content item placement campaign. The method 400 can select content items such as ads for rendering by the end user computing device 110 (ACT 405) based on the classification of the end user computing device 110 as an in-market device (ACT 340) or based on the classification of an online document as an in-market online document (ACT 345). For example, the score assigned to the end user computing device 110 can indicate that the end user computing device 110 is more suited for the rendering of content items relevant to the subject matter of the sub-category than other end user computing devices.

Based on the score assigned to the end user computing device 110, the method 400 can provide content items (ACT 410) for display by the end user computing device 110. For example, a content item placement computing device, which can be part of the data processing system 105 or a separate content item placement system, can select an ad or other content item for display with an online document by the end user computing device 110.

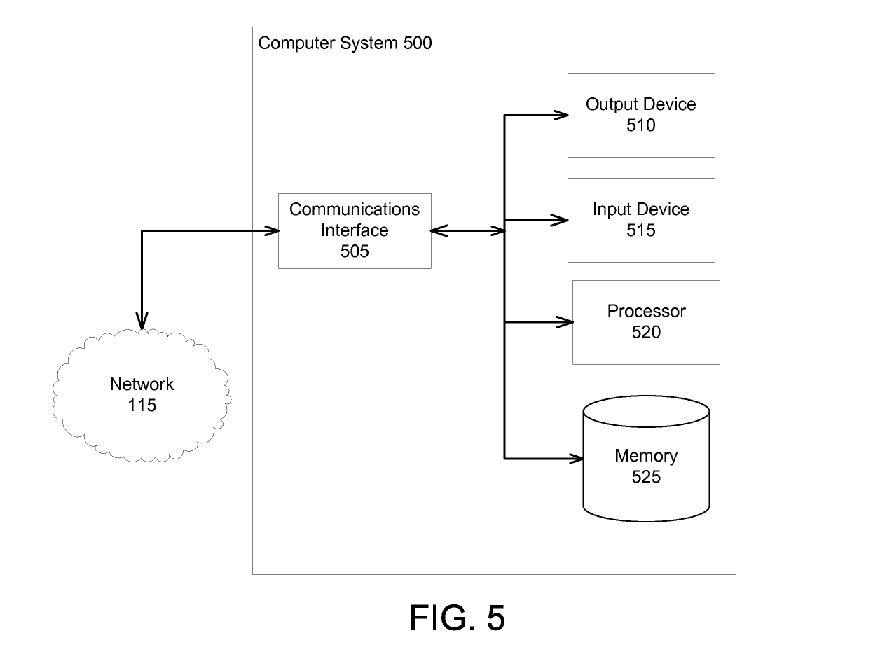

FIG. 5 shows the general architecture of an illustrative computer system 500 that may be employed to implement any of the computer systems discussed herein (including the system 100 and its components such as the data processing system 105, the activity detection module 130 or the score generation module 135) in accordance with some implementations. The computer system 500 can be used to provide information via the network 115, for example to identify the end user computing device 110 as an in-market device for display of content items as part of a content item placement campaign. The computer system 500 includes more processors 520 communicatively coupled to memory 525, one or more communications interfaces 505, and one or more output devices 510 (e.g., one or more display units) and one or more input devices 515. The processors 520 can be included in the data processing system 110 or the other components of the system 100 such as the activity detection module 130 or the score generation module 135.

The memory 525 can include computer-readable storage media, and can store computer instructions such as processor-executable instructions for implementing the operations described herein. The activity detection module 130, the score generation module 135, or the database 140 can include the memory 525 to store the score or network 115 based activity such as renderings or conversions of online documents. The processor(s) 520 can execute instructions stored in the memory 525 and can read from or write to the memory information processed and or generated pursuant to execution of the instructions.

The processor 520 can be communicatively coupled to or control the communications interface(s) 505 to transmit or receive information pursuant to execution of instructions. For example, the communications interface(s) 505 can be coupled to a wired or wireless network, bus, or other communication means and can allow the computer system 500 to transmit information to or receive information from other devices (e.g., other computer systems). One or more communications interfaces 505 can facilitate information flow between the components of the system 100. In some implementations, the communications interface(s) can be configured (e.g., via hardware components or software components) to provide a website as an access portal to at least some aspects of the computer system 500. Examples of communications interfaces 505 include user interfaces.

The output devices 510 can allow information to be viewed or perceived in connection with execution of the instructions. The input device(s) 515 can allow a user to make manual adjustments, make selections, enter data or other information, or interact in any of a variety of manners with the processor during execution of the instructions.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, e.g., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by the data processing system 105 or other data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

For situations in which the systems discussed herein collect personal information about users, or may make use of personal information, the users can be provided with an opportunity to control whether programs or features that may collect personal information (e.g., information about a user's actions, activities, preferences, or location), or to control whether or how to receive content from a content server of other data processing system that may be more relevant to the user. In addition, certain data may be anonymized in one or more ways before it is stored or used, so that personally identifiable information is removed when generating parameters. For example, a user's identity may be anonymized so that no personally identifiable information can be determined for the user, or a user's geographic location may be generalized where location information is obtained (such as to a city, ZIP code, or state level), so that a particular location of a user cannot be determined Thus, the user can have control over how information is collected about him or her and used by the content server.

The terms “data processing apparatus” “data processing system” “computing device” “module” “engine” or “computing device” encompass apparatuses, devices, and machines for processing data, including by way of example a programmable processor, a computer, a system on a chip, or multiple ones, or combinations, of the foregoing. The apparatuses can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination thereof The apparatus and execution environment can realize various different computing model infrastructures, such as web services, distributed computing and grid computing infrastructures. The activity detection module 130 and the score generation module 135 can include or share one or more data processing apparatuses, computing devices, or processors.

A computer program (e.g., a program, software, software application, script, or code) can be written in a programming language, including compiled or interpreted languages, declarative or procedural languages, and can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

The subject matter described herein can be implemented in a computing system (e.g., the data processing system 105) that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 100 or system 600 can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Operations depicted in the drawings need not be performed in the particular order shown or in sequential order, and all illustrated operations need not be performed. Operations described herein can be performed in a different order. The separation of various system components does not require separation in all implementations, and the described program components can be into a single hardware or software product. For example, the activity detection module 130 and the score generation module 135 can be a single module, a logic device having one or more processing circuits, or part of a content item placement system.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementation,” “an alternate implementation,” “various implementation,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof For example, the data processing system 105 can include an ad placement system, or the data processing system 105 can be separate from, but in communication with an ad placement system, for example via the network 115. Further, the score can also indicate that a particular web page or other online document is in market, e.g., more likely to have content items that are displayed with the online document converted by end user computing devices. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A computer implemented method, comprising:
determining, by an activity detection module executing on one or more processors of a data processing system, online documents rendered by a computing device during a time period;
classifying, by the activity detection module, the online documents into a top level subject matter category including a first sub-category and a second sub-category;
identifying, by the data processing system via a database, the first sub-category as an in-market category and the second sub-category as an out of market category;
associating, by the data processing system, a plurality of the online documents with the in-market category based on a first number of conversions of the plurality of the online documents by a plurality of computing devices;
determining, by the data processing system, a number of renderings by the computing device of the plurality of online documents in the in-market category during the time period;
determining, by the data processing system, a second number of conversions corresponding to the renderings by the computing device of the plurality of online documents in the in-market category during the time period;
generating, by a score generation module executing on the one or more processors of the data processing system, a score for the computing device by combining a first score based on the number of renderings of the plurality of online documents in the in-market category during the time period with a second score based on the second number of conversions of the plurality of online documents in the in-market category during the time period; and
classifying, by the score generation module based on the score satisfying a threshold, the computing device as one of an in-market device and an out of market device for placement of a content item as part of an online content item placement campaign, the in-market device having a higher likelihood to convert the content item than the out of market device.

2. The method of claim 1, comprising:
determining a number of the number of renderings of the plurality of online documents during the time period prior to a first conversion of the number of conversions; and
adjusting the score based on the number of the number of renderings.

3. The method of claim 1, comprising:
determining a number of the number of renderings of the plurality of online documents during the time period subsequent to a first conversion of the second number of conversions; and
adjusting the score based on the number of the number of renderings.

4. The method of claim 1, wherein the time period is two weeks, comprising:
comparing the score to the threshold value to determine that the computing device is the in-market device.

5. The method of claim 1, comprising:
classifying, based on the score, the computing device as the in-market device; and
de-classifying the computing device as the in-market device upon expiration of an in-market time period.

6. The method of claim 1, comprising:
classifying at least one of the plurality of online documents as one of an in-market online document and an out of market online document.

7. The method of claim 1, comprising:
selecting the content item based on the score; and
providing the content item via the computer network for display by the computing device.

8. The method of claim 1, comprising:
adjusting the score to increase a likelihood of classification of the computing device as the in-market device based on the conversion.

9. The method of claim 1, comprising:
adjusting the score to decrease a likelihood of classification of the computing device as the in-market device based on the conversion.

10. The method of claim 1, wherein the number of conversions of the plurality of online documents during the time period is a number of clicks on the plurality of online documents during the time period.

11. The method of claim 1, wherein the number of conversions of the plurality of online documents during the time period is zero.

12. The method of claim 1, comprising:
excluding a second plurality of the online documents from the in-market category.

13. (canceled)

14. A system of identifying in-market activity for placement of content as part of an online content item placement campaign via a computer network, comprising:
an activity detection module and score generation module executing on one or more data processors, and one or more storage devices storing instructions that when executed by the one or more data processors, cause the one or more data processors to perform operations comprising:
an activity detection module executing on one or more processors of a data processing system to:
classify online documents rendered within a time period by a computing device into a top level subject matter category including a first sub-category and a second sub-category;
identify, via a database, the first sub-category as an in-market category and the second sub-category as an out of market category;
associate a plurality of the online documents with the in-market category based on a first number of conversions of the plurality of the online documents by a plurality of computing devices;
determine a number of renderings by the computing device of the plurality of online documents during the time period; and
determine a second number of conversions corresponding to the renderings by the computing device of the plurality of online documents during the time period; and
a score generation module executing on the one or more processors of the data processing system to:
generate a score for the computing device by combining a first score based on the number of renderings of the plurality of online documents in the in-market category during the time period with a second score based on the number of conversions of the plurality of online documents in the in-market category during the time period; and
classify, based on the score satisfying a threshold, the computing device as one of an in-market device and an out of market device for placement of a content item as part of the online content item placement campaign.

15. The system of claim 14, wherein the interest identifier is one of a plurality of interest identifiers and the content item is a first content item, and wherein the instructions that when executed by the one or more data processors, cause the one or more data processors to perform operations comprising:
determining a number of the number of renderings of the plurality of online documents during the time period prior to a first conversion of the second number of conversions; and
adjusting the score based on the number of the number of renderings.

16. The system of claim 14, wherein the interest identifier is one of a plurality of interest identifiers and the content item is a first content item, and wherein the instructions that when executed by the one or more data processors, cause the one or more data processors to perform operations comprising:
determining a number of the number of renderings of the plurality of online documents during the time period subsequent to a first conversion of the second number of conversions; and
adjusting the score based on the number of the number of renderings.

17. The system of claim 14, wherein the time period is two weeks, and wherein the interest identifier is one of a plurality of interest identifiers and the content item is a first content item, and wherein the instructions that when executed by the one or more data processors, cause the one or more data processors to perform operations comprising:
comparing the score to the threshold value to determine that the computing device is the in-market device.

18. The system of claim 14, wherein the interest identifier is one of a plurality of interest identifiers and the content item is a first content item, and wherein the instructions that when executed by the one or more data processors, cause the one or more data processors to perform operations comprising:
classifying, based on the score, the computing device as the in-market device; and
de-classifying the computing device as the in-market device upon expiration of an in-market time period.

19. A non-transitory computer readable storage device storing instructions that when executed by an activity detection module and a score generation module having one or more data processors, cause the one or more data processors to perform operations comprising:
determining online documents rendered by a computing device within a time period via the computer network;
classifying the online documents into a top level subject matter category including a first sub-category and a second-subcategory;
identifying the first sub-category as an in-market category and the second sub-category as an out of market category;
associating a plurality of the online documents with the in-market category based on a first number of conversions of the plurality of the online documents by a plurality of computing devices;
determining a number of renderings by the computing device of the plurality of online documents during the time period;
determining a second number of conversions corresponding to the renderings by the computing device of the plurality of online documents during the time period;
generating a score for the computing device by combining a first score based on the number of renderings of the plurality of online documents in the in-market category during the time period with a second score based on the second number of conversions of the plurality of online documents in the in-market category during the time period; and
classifying, based on the score satisfying a threshold, the computing device as one of an in-market device and an out of market device for placement of a content item as part of the online content item placement campaign.

20. The non-transitory computer readable storage medium device of claim 19, wherein the instructions that when executed by the one or more data processors, cause the one or more data processors to perform operations comprising:
classifying at least one of the plurality of online documents as one of an in-market online document and an out of market online document.
